(19) United States
(12) Patent Application Publication
(10) Pub. No.: US 2010/0128888 A1
(43) Pub. Date: May 27, 2010

(54) Automatic Audio Processing Mode Control

(75) Inventors: Terry A. Junge, Scotts Valley, CA (US); Richard T. Brockway, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/545,012

(22) Filed: Aug. 20, 2009

Related U.S. Application Data
(63) Continuation-in-part of application No. 12/276,020, filed on Nov. 21, 2008.

(51) Int. Cl. H04R 1/10; G10L 19/00; H04L 12/66

(52) U.S. Cl. 381/74; 704/201; 370/352

(57) ABSTRACT

A telecommunications device, system, and method for automatically controlling an audio processing mode are provided. In one embodiment, the device comprises a transmit (TX) channel; a receive (RX) channel; and a signal processor configured to detect when the TX channel of the device has been placed in an active state and to apply a telephony-specific or multimedia-specific audio processing algorithm to the RX channel depending upon a state of the TX channel.

### CROSS-REFERENCE TO RELATED APPLICATIONS

This application is a continuation-in-part of U.S. application Ser. No. 12/276020, filed Nov. 21, 2008, the contents of which are incorporated by reference herein for all purposes.

### BRIEF DESCRIPTION OF THE INVENTION

This invention relates to telecommunications (telecom) in general, and more particularly, to methods and apparatus for automatically enabling and disabling audio processing modes in telecom headsets and headset adapters.

### BACKGROUND

In full duplex telephony, “sidetone” comprises a form of intentional feedback to the user of a telecom device, such as a telephone handset or headset, that enables the user to hear his own voice and thereby ascertain that a connection, or communication circuit, is open between the user and a far-end respondent, and also as a means for modulating the volume and speech formatives of the user's voice for effective communication. When the user speaks, his voice is sensed by the microphone of the device and introduced (at a reduced level) into the earpiece of the device so that the user hears himself speaking. Without sidetone, users cannot hear their own voice in the earpiece, and may conclude that the device is not working, or may speak either too softly or too loudly for effective communication.

Digital telecom devices typically lack the mechanical acoustics and circuitry that are present in older analog telephones for creating sidetone and therefore typically include electronic circuitry that generates the sidetone. An example of such a sidetone generator can be found in, e.g., U.S. Pat. No. 7,330,739 to S. Somayajula, which is incorporated by reference herein for all purposes.

In voice-over-internet-protocol (VOIP) telephony, headsets coupled via, e.g., a universal serial bus (USB) connection to a host computer, typically a personal computer (PC) acting as a telephone host, constitute the telecom devices of choice. Special USB adapters are also available that can be used to couple conventional corded analog telecom headsets to a suitably programmed PC telephone host. These headsets and adapters are typically marketed as both VOIP and hi-fidelity computer audio devices, i.e., as “multifunction” devices that can be used for both telephony and pure listening activities, such as the audition of music, e.g., MP3 files, or multimedia presentations.

By default, these devices have sidetone turned on at all times. This does not present a problem if the user of the headset is engaged exclusively in VOIP telephonic activities, where, as above, sidetone is a desirable feature. However, if the user is listening to music or simply sitting idly, the user may not want to have background noise or his own voice injected into the headset earpiece(s). If the user does not want sidetone on, the sidetone of the device must be turned off manually. This requires the user to open the audio mixer console of the PC's operating system (OS), e.g., Windows, and manually turn the sidetone off. Then, when sidetone in the device is wanted again, the user must turn it back on manually, again using the OS mixer console.

In a similarly related problem, headsets or headset adapters may utilize different algorithms depending on the type of application. For example, different algorithms may be used to enhance a VoIP telephone call, such as an acoustic echo cancellation algorithm, telephony specific EQs, versus a multimedia presentation, in which telephony-specific algorithms may be disabled and high fidelity EQs may be enabled. However, in order to switch between a telephony mode and a multimedia mode, the user must typically have specific software installed and must manually switch between the modes. The process of manually navigating the OS mixer or audio mode processing switch is time consuming and not intuitive to technically unsophisticated users, and can result in missed calls and degraded listening experiences.

### SUMMARY

In accordance with the present disclosure, an automatic audio processing mode control feature of a telecom device, such as a headset or headset adapter that is coupled to a telephone host device, such as a PC or a digital phone, is operable to sense when the transmit (TX) channel between the two devices is active and to automatically enable telephony specific algorithms of the device, and additionally, to automatically disable telephony specific algorithms and enable multimedia specific algorithms of the device when the TX channel is not active.

In one example embodiment, a telecommunications device, system, and method for automatically controlling an audio processing mode are provided. In one embodiment, the device comprises a transmit (TX) channel; a receive (RX) channel; and a signal processor configured to detect when the TX channel of the device has been placed in an active state and to apply a telephony-specific or multimedia-specific audio processing algorithm to the RX channel depending upon a state of the TX channel.

A better understanding of the above and many other features and advantages of the novel sidetone control feature of the present disclosure may be obtained from a consideration of the detailed description of some example embodiments thereof below, particularly if such consideration is made in conjunction with the several views of the appended drawings, wherein like elements are referred to by like reference numerals throughout.

### BRIEF DESCRIPTION OF THE DRAWINGS

FIG. 1 is a perspective view of an example embodiment of an adapter for coupling an analog telecommunications headset to a host device in accordance with the present disclosure;

FIG. 2 is a perspective view of an example embodiment of a telecom headset that may be used for both telecommunication and listening-only activities;

FIG. 3 is a hardware block diagram of an adapter for coupling an analog telecommunications headset to a host device in accordance with the present disclosure;

FIG. 4 is a diagram of the DSP firmware signal flow in an adapter for coupling an analog telecommunications headset to a host device in accordance with the present disclosure;

FIG. 5 is a table illustrating a user configurable state of a telecom device incorporating the example sidetone control apparatus;

FIG. 6 is a logic flow diagram of an example embodiment of a method for automatically controlling sidetone in a telecommunication headset in accordance with the present disclosure;

FIG. 7 is a diagram of the DSP firmware signal flow in an adapter for coupling an analog telecommunications headset to a host device in accordance with another embodiment of the present disclosure;

FIG. 8 is a table illustrating a user configurable state of a telecom device incorporating the example audio processing mode control apparatus;

FIG. 9 is a logic flow diagram of an example embodiment of a method for automatically controlling audio processing modes in a telecommunication headset in accordance with the present disclosure; and

FIG. 10 illustrates an embodiment of another method for automatically controlling audio processing modes in accordance with the present disclosure.

### DETAILED DESCRIPTION

In accordance with an embodiment of the present disclosure, an automatic sidetone control feature of a telecom device, such as a digital headset or an analog headset adapter coupled to a digital telephone host device, such as a PC or a digital telephone, is operable to detect when the TX channel between the two devices is either active or inactive and to automatically turn the sidetone of the telecom device on and off, respectively, in response thereto without need for manual intervention by the user.

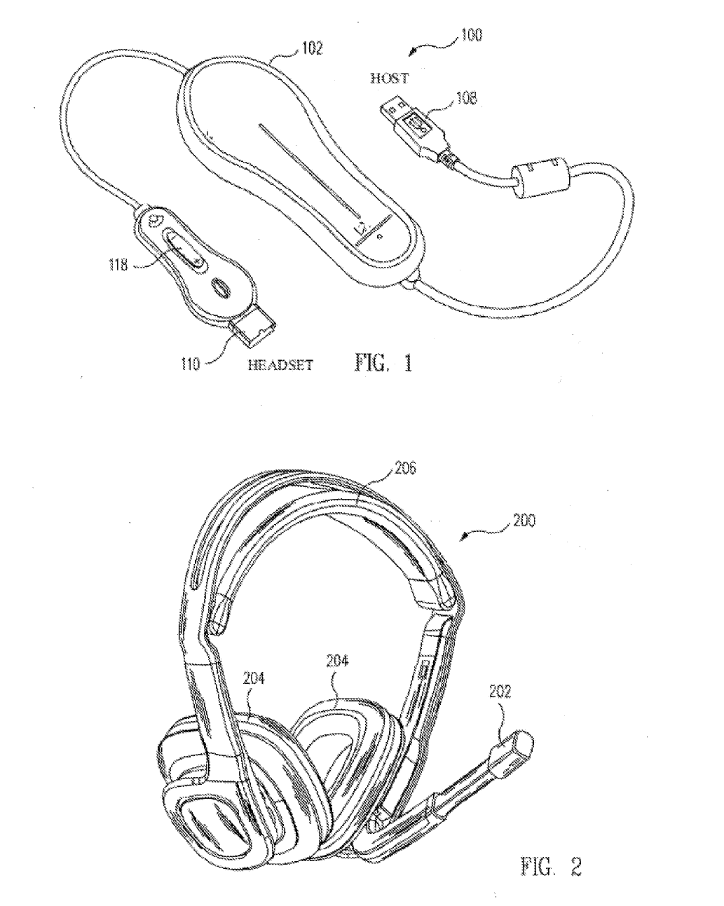

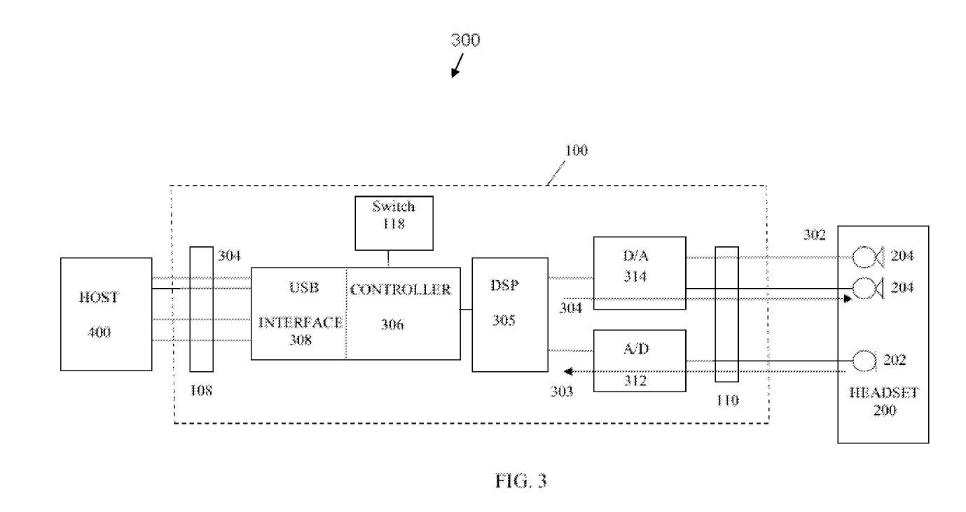

FIG. 1 is a perspective view of an example embodiment of one type of telecom device, viz., an adapter 100 for coupling a conventional analog telecom headset to a host digital computer or digital telephone (not illustrated) in accordance with the present disclosure. FIG. 2 is a perspective view of an example embodiment of another type of telecom device, viz. a headset 200 that, in the case of a digital headset, may be directly coupled to a host digital computer or digital telephone (not illustrated), and in the case of a conventional analog headset, may be coupled thereto through the adapter 100 of FIG. 1. In either case, a headset may be used for both bidirectional telephony and listening-only activities. FIG. 3 is a hardware block diagram of a telecommunication system 300 incorporating an example embodiment of an automatic sidetone generator and control apparatus in accordance with the present disclosure.

With reference to FIGS. 1 and 2 the headset adapter 100 includes a main body 102 housing circuitry which is adapted to, inter alia, couple an analog headset 200, such as the example headset of FIG. 2, to a host computer or digital telephone or other host device 400, as described in more detail below. As illustrated in FIG. 2, the analog headset 200 comprises a microphone 202, at least one audio speaker or earpiece 204 (also referred to as a receiver), and an apparatus 206, such as the resilient headband, for holding the headset on a user's head such that the microphone 202 is disposed adjacent to the user's mouth and at least one earpiece is disposed adjacent to one of the user's ears. Other known types of headset holding mechanisms, such as ear loops and neck bands, can also be used. Referring to FIG. 3, the microphone 202 comprises a transducer, such as a dynamic, electret or piezoelectric transducer, that is operable to detect acoustic signals, such as the sounds of a user's voice, to convert the acoustic signals to corresponding electrical signals, and to couple the electrical signals onto a TX channel 303 for ultimate transmission to a far-end respondent. The earpiece transducer 204 is operable to receive electrical signals via an RX channel 304, to convert the electrical signals to corresponding audible acoustic signals, and to output the acoustic signals to one of the user's ears.

The adapter body 102 may contain a printed circuit board (not illustrated) on which one or more active circuit devices, such as integrated circuits (ICs) and one or more digital signal processors (DSPs) 305 are mounted and interconnected. In one advantageous embodiment, substantially all of the active circuitry may be embodied in a single, dedicated signal processing chip. The adapter firmware of DSP 305 controls circuitry for generating and controlling a sidetone signal in the headset 200, which, as discussed above, can be implemented in a variety of known ways, by coupling at least a portion of a TX signal from the microphone 202 to speaker(s) 204.

As those of skill in the art will appreciate, the particular example adapter 100 and associated analog headset 200 illustrated in FIG. 2 can comprise a monophonic system, or the adapter 100 and headset 200 may easily be augmented with a second RX channel 304 and earpiece 204, as illustrated in FIG. 2 and 3, to form a binaural or stereophonic system. In a stereophonic system, each of two RX channels and earpieces are respectively dedicated to the right and left channels of the system. Although conventional VOIP telephony is universally monophonic in nature, the addition of a second channel to the system enables the headset 200 to function not only as a telecom device, but also as a means for delivering high fidelity stereophonic sound to a user.

With reference to FIG. 3, since the microphone 202 and earpiece transducers 204 of the headset 200 are typically analog in nature, the communication path 302 between the headset 200 and the adapter 100 is also typically analog in nature. Further, since the host device 400 is inherently digital in nature, the communication path 304 between the host device 400 and the adapter 100 is also digital in nature, and accordingly, the adapter circuitry further includes circuitry for converting a digital RX signal from the digital host device 400 to an analog RX signal for output to the analog speakers or earpiece(s) 204 of the headset 200, as well as circuitry for converting an analog TX signal from the microphone 202 of the headset 200 to a digital TX signal and outputting it to the host device 400. This signal converting circuitry may respectively include suitable digital-to-analog (D/A) 314 and analog-to-digital (A/D) converters 312 and/or audio coderdecoders (codecs) of a known type, and additionally, may be either off-the-shelf, standalone devices, or alternatively, may be integrated into a single DSP device in the adapter, such as those commercially available from Micronas, UAC 3556B.

The example headset adapter 100 further includes a connector 108 for coupling the adapter to the host device 400 via a digital communication protocol, as well as one or more connectors 110 for attaching the headset 200, such that the headset is coupled to the host device 400 through the adapter 100. In the particular example embodiment of FIGS. 1 and 3, the adapter 100 communicates with the host device 400 via the universal serial bus (USB) protocol at USB interface 308 and controller 306, and accordingly, the host connector 108 in this illustrative embodiment comprises a conventional USB connector.

However, it should be understood that the particular data communication protocol by which the adapter 100 communicates with the host device 400 is not limited to the USB protocol, and the adapter may instead communicate with the host device 400 by means of another digital communication protocol, such as pulse code modulation (PCM), Microsoft AC '97, IEEE 1394 (Firewire), AES/EBU (AES3), S/PDIF, MADI (AES10), Intel High Definition Audio (HD Audio), mlan, mp3, and WAV protocols, or another digital protocol, and accordingly, the connector 108 may comprise a correspondingly appropriate alternative connector type. The plug(s) (not illustrated) of the analog headset 200 may be comprised, of one or more conventional analog plugs, e.g. ⅛ inch analog plugs, including one each for the microphone 202 and the speaker(s) or earpiece(s) 204 thereof. Alternatively, the headset may incorporate a single, integrated plug through which the TX and RX signals 303, 304 are coupled into/from the headset 200. Still further, one or both of the links between the adapter 100 and the host device 400 and the headset 200 may be a wireless link, and the adapter 100 may be integrated with the host device 400 or the headset 200.

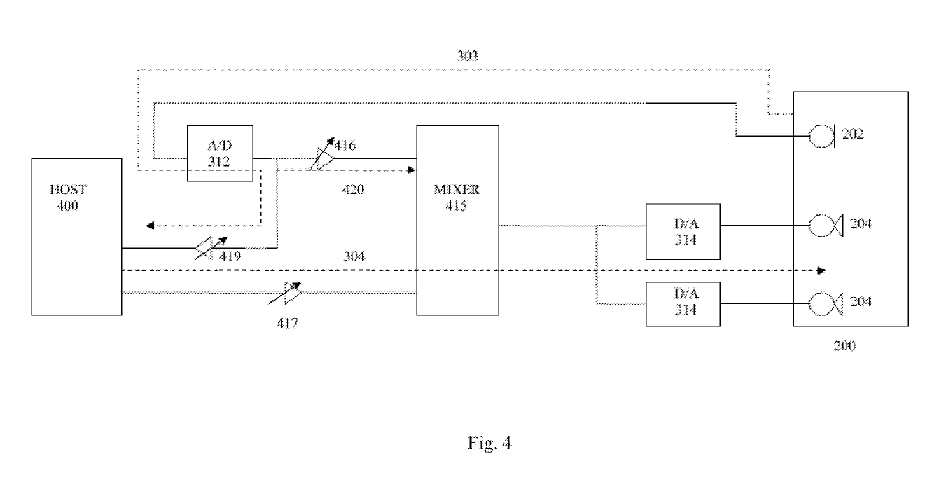

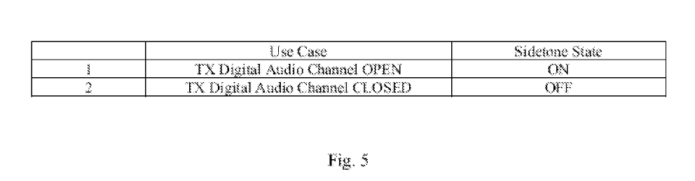

Referring now to FIG. 4, illustrated is the signal flow of a particular USB embodiment of the invention. In the USB communication protocol, all data transmissions travel to or from a device “endpoint” via a software “pipe” established between the device and the host at the time of system power-up (“enumeration”) or when the device is later connected to the host. Endpoint 0, for example, is a default bidirectional control point, always accessible. Industry standard USB Specification 2.0 describes the bus attributes, protocol definitions, types of transactions and programming interface for USB devices. USB Device Class Definition for Audio Devices 1.0 defines USB audio transport mechanisms. Both specifications are incorporated by reference herein. Other endpoints are uniquely identifiable portions of a USB device that are the terminus of communication flow between the host and device.

Following the TX path signal flow 303, an audio signal from microphone 202 of the headset 200 is converted to a digital stream by A/D 312 and the signal is directed to digital TX amplifier 419. Amplifier 419 can be used as a volume control for the TX signal path. Output from amplifier 419 is provided to the USB interface 308. This function is defined as “endpoint 1”. Thus, endpoint 1 is allocated to the TX function addressable by the host device 400 to initiate the transfer of audio data from the headset 200 to the host device 400 under the host's control, and endpoint 1 is the terminus of the TX communication with host device 400. To effect an audio TX path from the headset 200 to the host, the host requests a change for endpoint 1 and its pipe from “alternate 0” (closed channel with zero bandwidth assigned) to “alternate 1” (open channel of appropriate bandwidth on the bus). That is, endpoint 1 is toggled from a “0” or “inactive” mode to a “1” or “active” mode. In the inactive mode, the headset 200 is incapable of transmitting audio data to the host device 400, and in the active mode, the headset 200 transmits packets of audio data to the host device 400 isochronously and without error correction under the control of the host device 400.

Referring again to FIG. 4, the host device 400 provides a digital RX signal 304 at the USB interface 308 defined as “endpoint 2”. This data stream of digital signal 304 can carry monaural or stereo audio information. The data is input to RX amplifier 417, which can be configured as a volume control that allows a user to set RX level via controller 306. Data flows from amplifier 417 to digital mixer 415. Mixer 415 then provides RX signal 304 to D/A(s) 314 which in turn drive speaker(s) 204. Endpoint 2 is the terminus of the RX signal from the host device 400 to the adapter 100 addressable by the host device 400 to initiate the transfer of audio data from the host device 400 to the speaker(s) 204 under the host's control.

When endpoint 1 and its pipe are open, analog signals from microphone 202 of headset 200, after conversion to a digital stream by A/D converter 312, also flow to digital amplifier 416. Amplifier 416 provides a level control of the digital TX signal 303 input to mixer 415 under the command of controller 306. Amplifier 416 can adjust the feedback level of TX signal 303 from zero (no sidetone) to a nominal value representing a desired sidetone level. Mixer 415 then mixes the desired TX signal with the RX signal 304 from digital amplifier 417.

In accordance with this embodiment of the invention, controller 306 is programmed to monitor the status of the TX channel. If the TX channel is in an open condition (endpoint 1 in active mode), amplifier 416 is set to nominal gain by the controller 306 and a desired level of the TX signal 303 is mixed with the RX 304 signal in mixer 415. This combined signal is sent through D/A 314 to the speakers 204 and the headset wearer hears sidetone. When the TX channel is closed by the host device 400 (endpoint 1 in inactive mode), amplifier 416 is set to 0 gain level by controller 306 and mixer 415 has no TX signal input. Only the RX signal 304 from the host device 400 is present at the output of mixer 415 and the headset wearer will hear no sidetone. Thus, headset adapter 100 provides an automatic sidetone control function, which in this embodiment, comprises logic and circuitry for detecting when the TX channel 303 of the adapter has been placed in an open or active mode by the host device 400 and for enabling a sidetone path 420 between the TX and RX channels 303 and 304 in response thereto, as well as logic and circuitry for detecting when the TX channel 303 from the headset has been placed in the closed or inactive mode and for disabling the sidetone path in response thereto. In the example USB adapter of FIGS. 3 and 4, this function is affected by logic (firmware) incorporated in the programming of the adapter's controller 306.

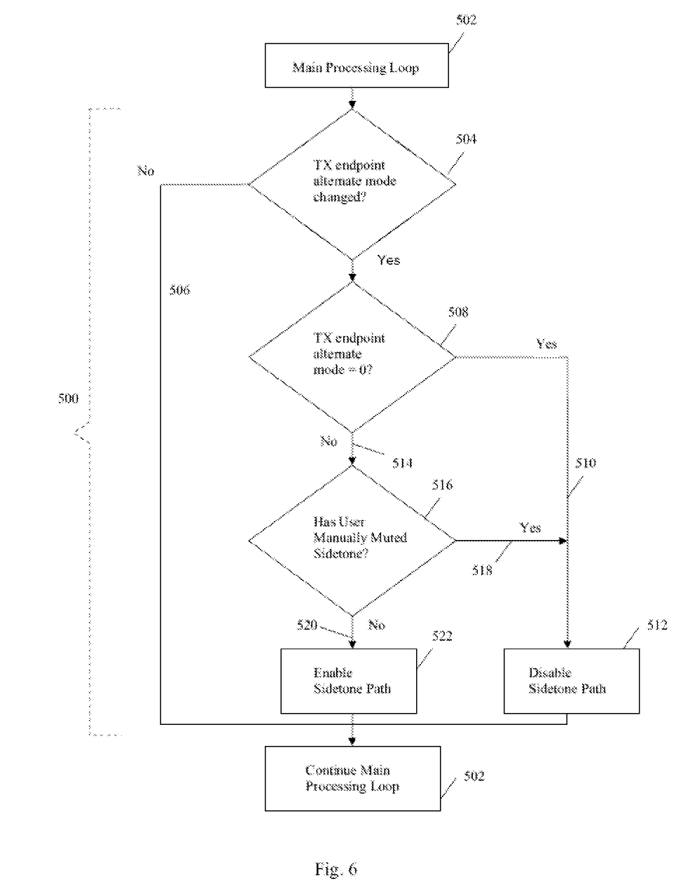

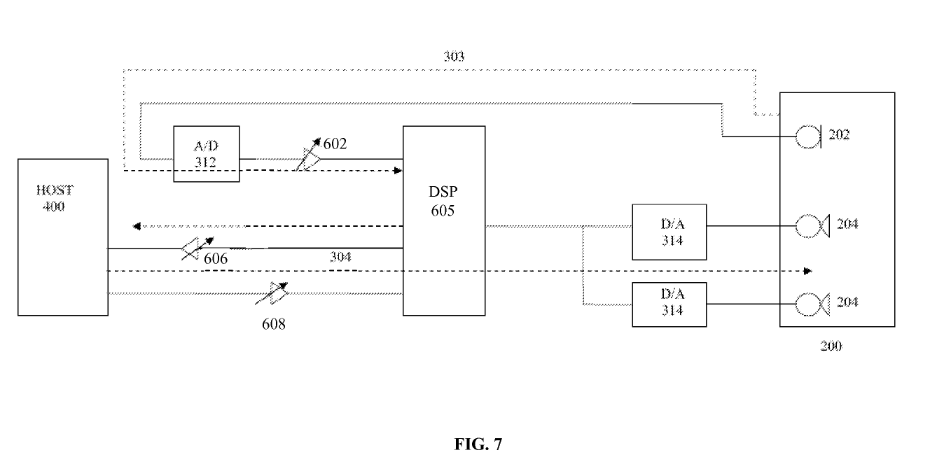

FIG. 5 is a logic table used in the sidetone generating and path controller portion 306 of the circuitry of the adapter 100 to detect a change in the alternate mode of the TX endpoint of the system and to automatically enable or disable the sidetone path 420 (FIG. 4) in response thereto. As shown in FIG. 6, the example method 500 may comprise a subroutine executed within a main processing loop 502 of the adapter 100's processor during operation.

Thus, in step 504 of the sidetone controller method 500 of FIG. 6, the processor of the adapter 100 or headset 200 checks to determine whether the endpoint 1 alternate mode has changed, i.e., from a 0 to a 1 or vice versa, since the last processor cycle. If it determines that no change has occurred, i.e., a “No” determination, the balance of the subroutine is bypassed via the branch 506 and the processor proceeds with the main processing loop 502. However, if the endpoint alternate mode has changed, i.e., a “Yes” determination, then at step 508, the processor determines whether the TX endpoint mode has been changed to 0, i.e., the disabled mode. If a Yes determination is made, the method proceeds via branch 510 to step 512, at which the processor disables the sidetone path 420, so that no sidetone is coupled onto the RX channel 304, and hence, no sidetone is heard by the user, whereupon the processor continues with the main processing loop 502, as above.

On the other hand, if a “No” determination is made at step 508, then the method 500 proceeds via branch 514 to step 516, where a determination is made as to whether the user has manually muted sidetone, e.g., through a telephony or listening application program running on the host device 400, or by manually actuating a sidetone muting switch 118 on the headset adapter 100 or a sidetone muting switch on the headset. If a “Yes” determination is made at step 516, the method proceeds via branch 518 to step 512, where, as above, the processor disables the sidetone path 420, and then continues with the main processing loop 502. However, if a “No” determination is made at step 516, i.e., the user has not manually muted sidetone, then the method proceeds via branch 520 to step 522, at which the processor enables the sidetone path 420, so that sidetone from the microphone 202 is coupled onto the RX channel 304, and hence, is heard by the user through the earpiece 204 of the headset 200, then continues on with the main processing loop 502.

As may be seen from the foregoing, the TX channel 303 is defined as “active” or “open” when the host device 400 requests audio data from the microphone 202. This occurs, for example, when a VoIP phone call is either initiated or received by the user. When the host device 400 wants microphone audio data, it sends a control transfer instruction to the adapter 100 via the digital audio communication path 304 that tells the adapter 100 to supply the microphone audio. When the processor of the adapter 100 receives this command, it begins supplying microphone audio data to the host device 400 via the USB interface 308, and at the same time, controller 306 enables the sidetone path 420. At all other times, the controller disables the sidetone path. These two states are illustrated in the sidetone control logic table of FIG. 5.

An example use case of the automatic sidetone controller is one in which a user is initially listening to music on a host device 400 (e.g. a personal computer) with an analog telecom headset 200 coupled to the host device 400 via a USB headset adapter 100 equipped with the novel automatic sidetone controller. In such a case, no distracting sidetone is present in the headset, because the TX channel 303 of the system is inactive. The user may then receive a VoIP phone call via, e.g., the Skype service. The user may then quickly switch to the call, causing the TX channel 303 of the adapter 100 to become active. As above, the sidetone controller 306 portion of the adapter's processor immediately detects this change in mode, and in response, automatically enables the sidetone path 420 of the adapter 100, as above. After the user completes the call, i.e., “hangs up,” the TX 303 channel becomes inactive, i.e., in the USB example, the “end-point 1” alternate mode is set to 0, or inactive. The sidetone controller detects this change, and automatically disables the sidetone path 420, so that the user may resume listening to the music without having to access the audio mixer function of the host device 400.

As described above, for additional functionality, the adapter 100 may include a mechanism, such as a switch 118 (FIG. 3), manually operable by the user for selectively activating and deactivating the automatic sidetone generator via the controller 306. When active, the sidetone generator and controller 306's operation is as described above and illustrated in FIGS. 5 and 6. However, when sidetone is muted by the user, i.e., when the sidetone generator is manually deactivated by the user, its operation reverts to the default operation described above, in which sidetone is manually activated or deactivated by the user through the audio mixer function of the host device 400.

The primary advantages of the automatic sidetone generator and controller 306 is that sidetone is present only when the user wants it to be and that its presence or absence is invoked automatically, without the need for manual intervention by the user.

Referring now to FIGS. 7-9 in conjunction with FIGS. 1-3, an embodiment for automatically controlling audio processing modes is disclosed. In accordance with an embodiment of the present disclosure, an automatic audio processing mode control feature of a telecom device, such as a digital headset or an analog headset adapter coupled to a digital telephone host device, such as a PC or a digital telephone, is operable to detect when the TX channel between the two devices is either active or inactive and to automatically select a telephony specific or multimedia specific audio processing algorithm of the telecom device in response thereto without need for manual intervention by the user.

As similarly described above, FIG. 1 is a perspective view of an example embodiment of one type of telecom device, viz., an adapter 100 for coupling a conventional analog telecom headset to a host digital computer or digital telephone (not illustrated) in accordance with the present disclosure. FIG. 2 is a perspective view of an example embodiment of another type of telecom device, viz. a headset 200 that, in the case of a digital headset, may be directly coupled to a host digital computer or digital telephone (not illustrated), and in the case of a conventional analog headset, may be coupled thereto through the adapter 100 of FIG. 1. In either case, a headset may be used for both bidirectional telephony, such as through VoIP, and listening-only activities, such as listening to music or viewing multimedia applications. FIG. 3 is a hardware block diagram of a telecommunication system 300 incorporating an example embodiment of an audio processing mode control apparatus in accordance with the present disclosure. Features and elements of FIGS. 1-3 are applicable in this embodiment of the present disclosure, and repetitive descriptions of the same or similar elements as those described above may not be fully included here although applicable to this embodiment of the present disclosure.

Adapter body 102 may contain a printed circuit board (not illustrated) on which one or more active circuit devices, such as integrated circuits (ICs) and one or more digital signal processors (DSPs) 305 are mounted and interconnected. In one advantageous embodiment, substantially all of the active circuitry may be embodied in a single, dedicated signal processing chip. The adapter firmware of DSP 305 controls circuitry for selecting and applying audio processing algorithms in the headset 200 dependent upon whether the transmit (TX) channel between the headset and host is active.

Referring now to FIG. 7 in conjunction with FIG. 3, the signal flow of a particular USB embodiment of the invention is illustrated. Following the TX path signal flow 303, an audio signal from microphone 202 of the headset 200 is converted to a digital stream by A/D 312 and the signal is directed to digital TX amplifier 602. Amplifier 602 can be used as a volume control for the TX signal path. Output from amplifier 602 is provided to DSP 605 which is configured to apply telephony-specific or multimedia-specific algorithms to the TX signal depending upon the state of the transmit (TX) channel between the headset and the host. When the TX channel is active, telephony-specific algorithms of the device are enabled, and when the TX channel is not active, telephony-specific algorithms are disabled and multimedia-specific algorithms of the device are enabled. Applicable telephony-specific algorithms include but are not limited to acoustic echo cancellation, telephony-specific EQs, multiband compression, and expansion.

The processed TX signal from DSP 605 is then provided to the USB interface 308 (FIG. 3). This function is again defined as “endpoint 1”. Thus, endpoint 1 is allocated to the TX function addressable by the host device 400 to initiate the transfer of audio data from the headset 200 to the host device 400 under the host's control, and endpoint 1 is the terminus of the TX communication with host device 400. To effect an audio TX path from the headset 200 to the host, the host requests a change for endpoint 1 and its pipe from “alternate 0” (closed channel with zero bandwidth assigned) to “alternate 1” (open channel of appropriate bandwidth on the bus). That is, endpoint 1 is toggled from a “0” or “inactive” mode to a “1” or “active” mode. In the inactive mode, the headset 200 is incapable of transmitting audio data to the host device 400, and in the active mode, the headset 200 transmits packets of audio data to the host device 400 through DSP 605 under the control of the host device 400. For example, when a host computer wants microphone audio USB data, the host may send a USB command to the USB adapter or headset to tell the adapter or headset to supply the microphone audio. When the adapter or headset interprets this command, it begins supplying the microphone audio to the host via USB and at the same time, the adapter or headset may automatically switch to a telephone audio processing mode. At all other times, it may be assumed that the user is not on a telephone call and the audio processing algorithm may be set to a multimedia audio processing mode.

Referring again to FIG. 7 in conjunction with FIG. 3, the host device 400 provides a digital RX signal 304 at the USB interface 308 (FIG. 3) again defined as “endpoint 2”. This data stream of digital signal 304 can carry monaural or stereo audio information. The data is input to RX amplifier 608, which can be configured as a volume control that allows a user to set RX level via controller 306 (FIG. 3). Data flows from amplifier 608 to DSP 605, which again is operable to apply telephony-specific or multimedia-specific algorithms to the RX signal depending upon the state of the transmit (TX) channel between the headset and the host. When the TX channel is active, telephony-specific algorithms of the device are enabled, and when the TX channel is not active, telephony-specific algorithms are disabled and multimedia-specific algorithms of the device are enabled. The processed RX signal 304 from DSP 605 is then provided to D/A(s) 314 which in turn drive speaker(s) 204. Endpoint 2 is the terminus of the RX signal from the host device 400 to the adapter 100 addressable by the host device 400 to initiate the transfer of audio data from the host device 400 to the speaker(s) 204 under the host's control.

In accordance with this embodiment of the invention, controller 306 (FIG. 3) is programmed to monitor the status of the TX channel. If the TX channel is in an open condition (endpoint 1 in active mode), DSP 605 is configured to apply telephony-specific algorithms to the TX and RX signals. At all other times (no microphone audio USB data requested and endpoint 1 in inactive mode), DSP 605 is configured to apply multimedia-specific algorithms to the RX signals). Thus, headset adapter 100 provides an automatic control function over audio processing algorithms, which in this embodiment, comprises logic and circuitry for detecting when the TX channel 303 of the adapter has been placed in an open or active mode by the host device 400 and for applying particular audio processing algorithms to the TX and RX channels 303 and 304 in response thereto, as well as logic and circuitry for detecting when the TX channel 303 from the headset has been placed in the closed or inactive mode and for applying alternative audio processing algorithms to the TX and RX channels in response thereto. In the example USB adapter of FIGS. 3 and 7, this function is affected by logic (firmware) incorporated in the programming of the adapter's controller 306.

In another embodiment of the present disclosure, the internal audio processing sample rate may also be adjusted when the audio processing mode is switched. For example, algorithms used for telephony-specific audio processing are resource intensive, requiring a relatively large number of MIPs, and thus these algorithms may be implemented at a lower sampling rate (e.g., 16 Ks instead of 48 Ks). However, for listening to music or other multimedia applications it is desirable to have audio bandwidths greater than telephony audio (e.g., 48 Ks instead of 16 Ks), and thus these algorithms may be implemented at a higher sampling rate than in the telephony mode. Accordingly, the internal audio processing sample rates of the adapters or headsets may automatically switch sampling rate based upon the audio processing mode.

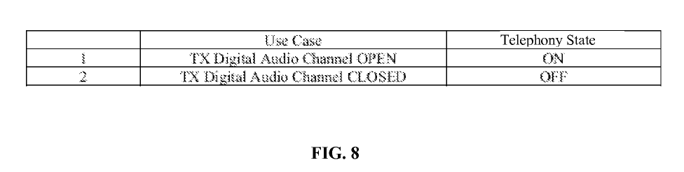

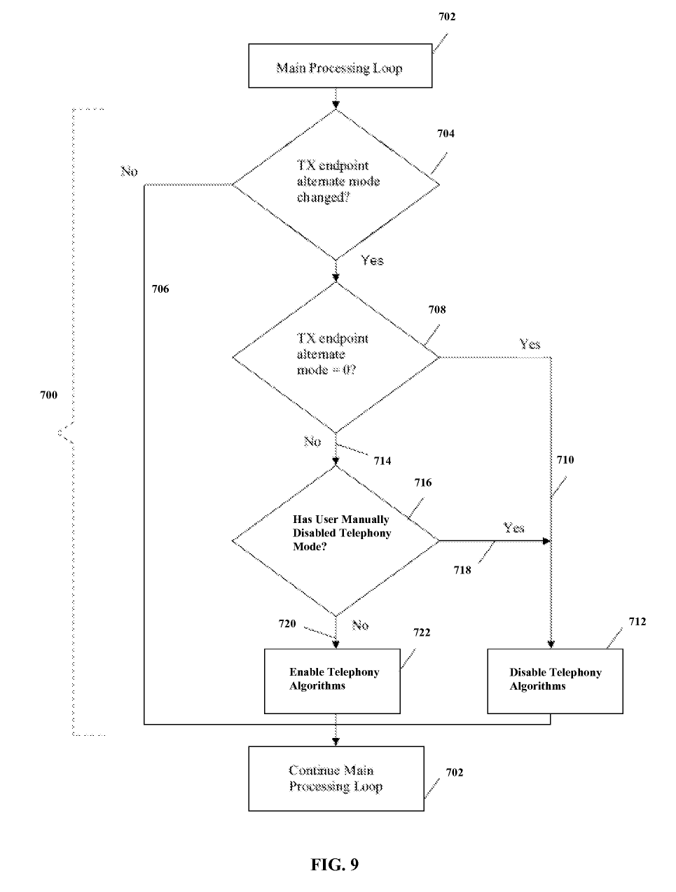

FIG. 8 is a logic table used in the controller portion 306 of the circuitry of the adapter 100 to detect a change in the alternate mode of the TX endpoint of the system and to automatically enable or disable an audio processing algorithm in response thereto.

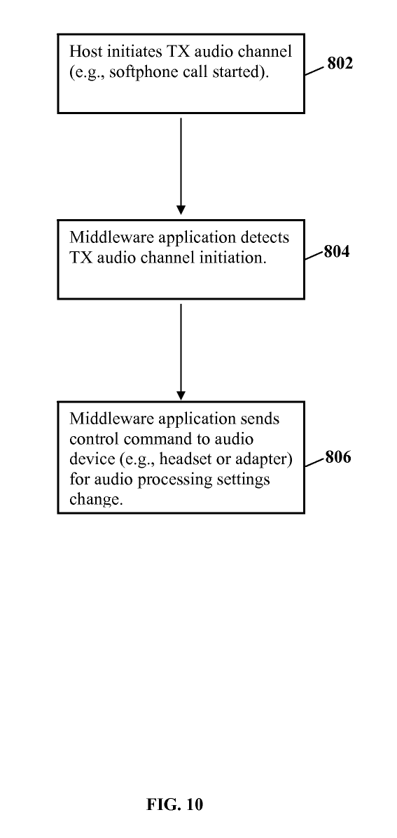

As shown in FIG. 9, an example method 700 may comprise a subroutine executed within a main processing loop 702 of the adapter 100's processor during operation. In step 704 of the audio processing mode controller method 700, the processor of the adapter 100 or headset 200 checks to determine whether the endpoint 1 alternate mode has changed, i.e., from a 0 to a 1 or vice versa, since the last processor cycle. If it determines that no change has occurred, i.e., a “No” determination, the balance of the subroutine is bypassed via the branch 706 and the processor proceeds with the main processing loop 702. However, if the endpoint alternate mode has changed, i.e., a “Yes” determination, then at step 708, the processor determines whether the TX endpoint mode has been changed to 0, i.e., the disabled mode. If a Yes determination is made, the method proceeds via branch 710 to step 712, at which the processor disables telephony-specific algorithms and either selects the multimedia-specific algorithm or returns to a default multimedia-specific algorithm to apply to the RX channel 304, whereupon the processor continues with the main processing loop 702, as above.

On the other hand, if a “No” determination is made at step 708, then the method 700 proceeds via branch 714 to step 716, where a determination is made as to whether the user has manually disabled the telephony mode, e.g., through a telephony or listening application program running on the host device 400, or by manually actuating a switch 118 on the headset adapter 100 or on the headset 200. If a “Yes” determination is made at step 716, the method proceeds via branch 718 to step 712, where, as above, the processor disables the telephony-specific algorithms and either selects the multimedia-specific algorithms or returns to a default multimedia processing mode, and then continues with the main processing loop 702. However, if a “No” determination is made at step 716, i.e., the user has not manually disabled telephony mode, then the method proceeds via branch 720 to step 722, at which the processor enables the telephony-specific algorithms to be applied to the TX and RX channels 303, 304 and then continues on with the main processing loop 702.

As may be seen from the foregoing, the TX channel 303 is defined as “active” or “open” when the host device 400 requests audio data from the microphone 202. This occurs, for example, when a VoIP phone call is either initiated or received by the user. When the host device 400 wants microphone audio data, it sends a control transfer instruction to the adapter 100 via the digital audio communication path 304 that tells the adapter 100 to supply the microphone audio. When the processor of the adapter 100 receives this command, it begins supplying microphone audio data to the host device 400 via the USB interface 308, and at the same time, controller 306 enables telephony-specific algorithms to be applied. At all other times, the controller disables the telephony mode. These two states are illustrated in the telephony control logic table of FIG. 8.

An example use case of the automatic audio processing mode controller is one in which a user is initially listening to music on a host device 400 (e.g. a personal computer) with an analog telecom headset 200 coupled to the host device 400 via a USB headset adapter 100 equipped with the novel automatic audio processing mode controller. In such a case, multimedia-specific algorithms, such as high fidelity EQ, is applied to the audio because the TX channel 303 of the system is inactive. The user may then receive a VoIP phone call via, e.g., the Skype service. The user may then quickly switch to the call, causing the TX channel 303 of the adapter 100 to become active. The controller 306 portion of the adapter's processor immediately detects this change in mode, and in response, automatically switches to a telephony mode in which telephony-specific algorithms are applied to the received and transmitted audio signals. After the user completes the call, i.e., “hangs up,” the TX 303 channel becomes inactive, i.e., in the USB example, the “endpoint 1” alternate mode is set to 0, or inactive. The controller detects this change, and automatically disables the telephony algorithms and switches back to a multimedia mode, so that the user may automatically resume listening to the music with high fidelity EQ without having to access the audio mixer function of the host device 400.

As described above, for additional functionality, the adapter 100 may include a mechanism, such as a switch 118 (FIG. 3), manually operable by the user for selectively activating and deactivating the telephony mode and/or the multimedia mode via the controller 306.

Referring now to FIG. 10, a flowchart is shown illustrating another method of automatically controlling audio processing modes via software located outside of the adapter or headset. For example, the functionality of the adapter or headset to detect a state or mode of the TX channel may be in the host device (e.g., a middleware application on a PC), where the middleware application is configured to send control commands to the audio device for setting changes to the audio processing mode depending upon the state of the TX channel. At step 802, the host initiates a TX audio channel (e.g., a softphone call is started). At step 804, the middleware application, for example located on a PC host, detects the TX audio channel initiation. At step 806, the middleware application sends a command to the audio device (e.g., a headset or adapter) to change an audio processing mode from a multimedia mode to a telephony mode such that different audio processing algorithms are applied to the audio signals.

The primary advantages of the automatic audio processing mode controller 306 is that in either a telephony application or a multimedia application, the audio processing algorithms will be optimized for those applications automatically without the need for manual intervention by the user.

As those of skill in the art will appreciate, although the methods and apparatus of the present disclosure have been described and illustrated herein with reference to certain specific example embodiments thereof, a wide variety of modifications and variations may be made to them without departing from the spirit and scope of the invention. For example, it should be understood that the functionality of the adapter 100 described above, including the automatic audio processing mode controller 306, may be incorporated directly into the headset 200, such that the adapter is eliminated and the resulting “digital” headset then comprises an integrated telecom device that connects directly to the host device 400 via, e.g., a USB or other digital type of connection. Furthermore, although various endpoints and channels of communication have been described, various other endpoints and/or channels may be used for bidirectional communication and monitoring for audio mode processing.

In light of the foregoing, the scope of the present invention should not be limited to that of the specific example embodiments described and illustrated herein, but rather, should be commensurate with that of the claims appended hereafter and their functional equivalents.

What is claimed is:

1. A telecommunications device for automatically controlling an audio processing mode, the device comprising:
a transmit (TX) channel;
a receive (RX) channel; and
a signal processor configured to detect when the TX channel of the device has been placed in an active state and to apply a telephony-specific or multimedia-specific audio processing algorithm to the RX channel depending upon a state of the TX channel.

2. The device of claim 1, further comprising digital circuitry adapted to couple the device in full duplex communication with a host device via a digital communication protocol.

3. The device of claim 2, wherein the digital communication protocol comprises one of the group consisting of the universal serial bus (USB), pulse code modulation (PCM), Microsoft AC '97, IEEE 1394 (Firewire), AES/EBU (AES3), S/PDIF, MADI (AES10), Intel High Definition Audio (HD Audio), mLan, mp3, and WAV protocols.

4. The device of claim 1, further comprising:
a microphone;
at least one earpiece; and
an apparatus for holding the headset on a user's head such that the microphone is disposed adjacent to the user's mouth and the at least one earpiece is disposed adjacent to one of the user's ears.

5. The device of claim 1, further comprising a switch for manually activating and deactivating the telephony-specific audio processing algorithm.

6. The device of claim 1, wherein the telephony-specific audio processing algorithm is selected from the group consisting of acoustic echo cancellation, telephony-specific EQs, multiband compression, and multi-band expansion.

7. The device of claim 1, further comprising:
a microphone operable to detect adjacent acoustic signals, convert the acoustic signals to corresponding electrical signals and couple the electrical signals onto the TX channel; and
at least one receiver operable to receive electrical signals from the RX channel, convert the electrical signals to corresponding audible acoustic signals and output the acoustic signals to a user's ear.

8. The device of claim 1, further comprising:
means for converting a digital RX signal received from a host device to an analog RX signal and outputting it to a headset; and
means for converting an analog TX signal received from the headset to a digital TX signal and outputting it to the host device.

9. The device of claim 8, wherein the signal converting means comprises at least one selected from the group consisting of a digital to analog (D/A) converter, an analog to digital (A/D) converter and a coder-decoder (codec).

10. A telephony system, comprising:
a digital host device disposed in communication with the Internet and operable to establish full duplex telecommunication between a user of the system and a far end respondent via a voice-over-internet protocol (VoIP); and
a telecommunications device coupled in full duplex communication with the host device via a digital communication protocol, the telecommunications device comprising:
a transmit (TX) channel;
a receive (RX) channel;
a first signal converter for converting a digital RX signal received from the host device to an analog RX signal;
a second signal converter for converting an analog TX signal received from the user to a digital TX signal; and
a signal processor configured to apply a telephony-specific or multimedia-specific audio processing algorithm to the RX channel depending upon a state of the TX channel.

11. The telephony system of claim 10, wherein the host device comprises a digital computer or a digital telephone.

12. The telephony system of claim 10, wherein the telecommunications device comprises a headset or a headset adapter.

13. The telephony system of claim 10, wherein the telecommunications device comprises a headset adapter coupled to the host device and an analog headset coupled to the host device through the adapter.

14. The telephony system of claim 10, wherein the digital communication protocol comprises one of the group consisting of the universal serial bus (USB), pulse code modulation (PCM), Microsoft AC '97, IEEE 1394 (Firewire), AES/EBU (AES3), S/PDIF, MADI (AES10), Intel High Definition Audio (HD Audio), mLan, mp3, and WAV protocols.

15. The telephony system of claim 10, wherein at least one of the first and second signal converters comprises one of the group consisting of a digital to analog (D/A) converter, an analog to digital (A/D) converter and a coder-decoder (codec).

16. The telephony system of claim 10, wherein the host device or the signal processor is configured to detect when the TX channel of the device has been placed in an active state.

17. A method for automatically controlling audio processing modes, the method comprising:
detecting when a transmit (TX) channel of a telecommunications device has been placed in an active state; and
applying a telephony-specific or multimedia-specific audio processing algorithm to a receive (RX) channel and/or the TX channel of the telecommunications device depending upon the state of the TX channel.

18. The method of claim 17, further comprising determining whether a user of the device has manually disabled the telephony-specific audio processing algorithms.

19. The method of claim 17, further comprising applying a telephony-specific audio processing algorithm to the TX and RX channels when the TX channel is in an open state.

20. The method of claim 17, further comprising applying a multimedia-specific audio processing algorithm to the RX channel when the TX channel is in a closed state.
